(19) United States
(12) Patent Application Publication
(10) Pub. No.: US 2011/0125698 A1
(43) Pub. Date: May 26, 2011

(54) METHOD AND SYSTEM FOR DETERMINING TASK SCHEDULING PROBABILITY

(76) Inventors: David R. Rome, Lone Tree, CO (US); Peter Allmond Tinker, West Hills, CA (US); Jason R. Fox, Thousand Oaks, CA (US)

(21) Appl. No.: 12/376,566

(22) PCT Filed: Aug. 17, 2007
(86) PCT No.: PCT/US07/76209

§ 371 Date: Feb. 5, 2009

Related U.S. Application Data
(60) Provisional application No. 60/838,644, filed on Aug. 18, 2006.

(51) Int. Cl. G06N 5/02

(52) U.S. Cl. 706/50

(57) ABSTRACT

Provided is a method of determining task scheduling probability. More specifically, the method includes establishing a set of task attributes. A database of prior task vectors in accordance with the set of task attributes then also provided, wherein each prior task vector representing a prior scheduled task. A new task is received having at least a subset of the task attributes. For this new task, a new task vector is generated based on the new task attributes. The new task vector is compared with the prior task vectors and the differences are recorded. The probability of successful scheduling is then evaluated based on the aggregate differences for each attribute. A system operable to perform the method is also provided.

### RELATED MATERIALS

This application claims priority to U.S. Provisional application 60/838,644 filed Aug. 18, 2006, entitled “Discrete Feature Mapping System” and incorporated herein by reference.

### FIELD

This invention relates generally to the scheduling of new activities in a schedule, and, in particular, to a system and method which predicts the success of scheduling a new task based on an evaluation of the new task and commonalities with prior successfully scheduled tasks.

### BACKGROUND

Simply stated, a schedule informs a party of what activity/activities are to take place, when the activity/activities will take place, and who will perform the activity/activities. A schedule may run for an hour, day, week, month, or other interval of time. Generally, the “when” quality is a specific reference to start an activity at a specific time and/or end that activity at a later specific time.

With respect to the “what” quality, a schedule may provide very generic activity information such as sleeping, eating, building, or some other activity. The “what” quality may also provide resource information—sleeping in bed 2, eating at table 5, or building at station 4.

With respect to the “who” quality—a schedule may provide information to observers of an activity regarding who is performing the activity, or the schedule may provide direction to a party to commence with or finish an activity. Typically, a schedule will also indicate free time, as in unscheduled time, as well as the busy time, as in time currently scheduled for activities.

A schedule may be assembled by scheduling activities in the order in which they are received, or in which they logically occur. A schedule may also be assembled by setting tasks for available resources by the order the resources come available. A schedule may also be assembled by prioritizing activities in descending or ascending order of preference. Where the time that an activity is to occur or might occur is important, the focus of placement may shift from simple order of preference, preferred resources, levels of priority, and/or combinations thereof at different times.

In many real world settings there are specific demands upon schedules. For any given resources (such as an aircraft, a satellite or a computer) there may be a finite availability both in terms of how long something may occur and how much may occur. Computer speeds are continuing to increase, but for each second of time a CPU has a finite number of operations to perform. A more powerful computer CPU resource may indeed execute more operations than a less powerful CPU resource, and such an option may or may not be taken into account when forming a schedule. In another example, an aircraft or satellite may not be over a particular spot on the earth at all times, and even when over a target area, may only be able to observe, deploy, gather, or perform a finite number of activities before returning to base or passing out of range.

In forming a schedule, often a group of tasks are batched together and processed collectively so as to form a schedule for an upcoming time period. Further still, after a schedule has been created, it is frequently necessary to insert a new activity or activities, and modify and/or delete one or more activities that have already been scheduled. In either case, it is not uncommon for tasks to compete for resources and time slots, and in many instances there may be more tasks desiring certain resource and time slots then can actually be scheduled.

To fill a schedule with activities competing for time slots, or to enter new activities into an existing schedule where the new activities compete with existing scheduled activities is far from easy. Many problems, and the algorithms that may be applied to them, are linear—double or triple the input and they will take twice or three times as long to complete. Others may be quadratic, cubic or another polynomial. When a class of problems is encountered where the solution is not polynomial, it may well be a nondeterministic polynomial—more commonly referred to as “NP-hard”.

Filling a schedule and inserting new activities into a schedule are activities that qualify as NP-hard NP-hard problems are well known and frequently encountered, yet no algorithm to solve them is known. A fast algorithm is one that will return the best solution quickly enough for the solution to actually be useful. If the solution takes years to compute, it is quite likely that the term of usefulness will have long expired.

A famous example of such an NP-hard problem is the Traveling Salesman. A salesman desires to visit each state capitol and wants to minimize his or her driving time. Within the 50 states there are 49! possible choices—and no algorithm is known to exist that will nicely solve this problem.

For a schedule, it may be that, given an infinite amount of time, a best solution may be found. However, during the instantiation of a schedule, and the subsequent modification of a schedule, real time continues to progress. As a result, by the time a best solution has been found, it is entirely possible that too much time will have passed and the issue will be moot.

A particular schedule's purpose may also drive how activities should be scheduled and new activities added. One popular method that has been used in the assembly and modification of a schedule is the “English Auction,” also known as the first-price, open-bid auction.

In an “English Auction,” activities bid on resources. All available resources and opportunities are considered in the auction. Both lower priority activities and higher priority activities bid. Higher priority activities have higher maximum bids so they will eventually win their preferred time slots, but not before accommodating lower priority activities. Indeed, a high priority activity with a low preference for a specific time spot may be usurped, and potentially deleted by one or more lower priority activities that have a higher preference for that specific time slot.

To state it another way, a low priority activity with a high preference for a time slot may usurp a high priority activity with a low preference for the same time slot. Further, a plurality of low preference activities may combine forces and collectively usurp a high priority activity if the combined preference is greater than the solo high priority preference.

Where the desire is to schedule the maximum number of activities, regardless of priority, an English Auction may be quite effective. However, if there is a premium placed on the scheduling of higher priority activities, then an English Auction may not offer the best solution. Indeed, if the mandate is to schedule as many events as possible, but no higher priority activity may ever be usurped by one or more lower priorities, then the English Auction approach will not be acceptable.

Mixed Integer methods have also been proposed to provide schedule modification. In a Mixed Integer method, however, each and every allowable possible permutation of activities is considered and evaluated. Even with the speed of modern computers, the focus upon trying all permutations for comparison makes Mixed Integer methods vastly impractical for all but the simplest schedules.

Moreover, the process of determining a schedule is far from an easy task, and for those desiring to have tasks included in the schedule, many factors are at issue. In many situations the operator requesting the scheduling of the event may be able to modify one or more parameters if it is known that doing so will increase the odds of scheduling success.

Indeed, when tasks are batched together for scheduling at a later date, and because the parameters of competing tasks are not known by the requesting party, the success or failure of a task to be scheduled may not be known for some period of time. By the time a failure to schedule is known, the ability to adjust a parameter may or may not be as easily performed and indeed the window of opportunity may have lapsed. In many situations further action may be dependent upon knowing that the task has indeed been scheduled. By not knowing whether the task has scheduled until the schedule has been formed, undue delay, cost and resource opportunity may be lost or otherwise wasted.

Hence, there is a need for a system and method to determine the probability of scheduling tasks in advance of submitting so as to overcome one or more of the technical problems found in existing scheduling systems.

### SUMMARY

This invention provides a method and system for determining the scheduling probability of new tasks within a schedule.

In particular, and by way of example only, according to one embodiment of the present invention, a method is provided for determining task scheduling probability, including: establishing a set of task attributes; providing a database of prior task vectors in accordance with the set of task attributes, each prior task vector representing a prior scheduled task; receiving a new task having at least a subset of the task attributes; generating a new task vector based on the new task attributes; comparing the new task vector to at least a subset of the prior task vectors and recording the differences between each task attribute; and evaluating the probability of the new task scheduling successfully based upon the aggregate differences for each attribute.

In yet another embodiment, provided is a system for determining task scheduling probability, including: a set of task attributes; a database operable to provide at least one prior task vector established in accordance with the set of task attributes, each prior task vector representing a prior scheduled task; an interface operable to receive a new task having at least a subset of the task attributes; a generator operable to receive the new task from the interface and generate a new task vector based on the new task attributes; an evaluator in connection with the database and the generator and operable to compare the new task vector with at least a subset of the prior task vectors and record the difference for each task attribute, the aggregate differences for each task attribute indicating a probability of the new task scheduling successfully.

Further, in yet another embodiment, provided is a computer-readable medium on which is stored a computer program for determining task scheduling probability, the computer program comprising instructions which, when executed by a computer, perform the steps of: establishing a set of task attributes; providing a database of prior task vectors in accordance with the set of task attributes, each prior task vector representing a prior scheduled task; receiving a new task having at least a subset of the task attributes; generating a new task vector based on the new task attributes; comparing the new task vector to at least a subset of the prior task vectors and recording the differences between each task attribute; and evaluating the probability of the new task scheduling successfully based upon the aggregate differences for each attribute.

### BRIEF DESCRIPTION OF THE DRAWINGS

FIG. 1 illustrates a new task having various forms based on different selections of task attributes and the corresponding representative new task vectors as well as a database of prior task vectors in accordance with at least one embodiment;

FIG. 2 illustrates a high level block diagram of a system for determining task scheduling probability in accordance with at least one embodiment;

FIG. 3 provides a flow diagram of a method system for determining task scheduling probability in accordance with at least one embodiment;

FIG. 4 provides tables of experimental results obtained from performing task scheduling perditions in accordance with at least one embodiment; and

FIG. 5 is a block diagram of a computer system in accordance with at least one embodiment.

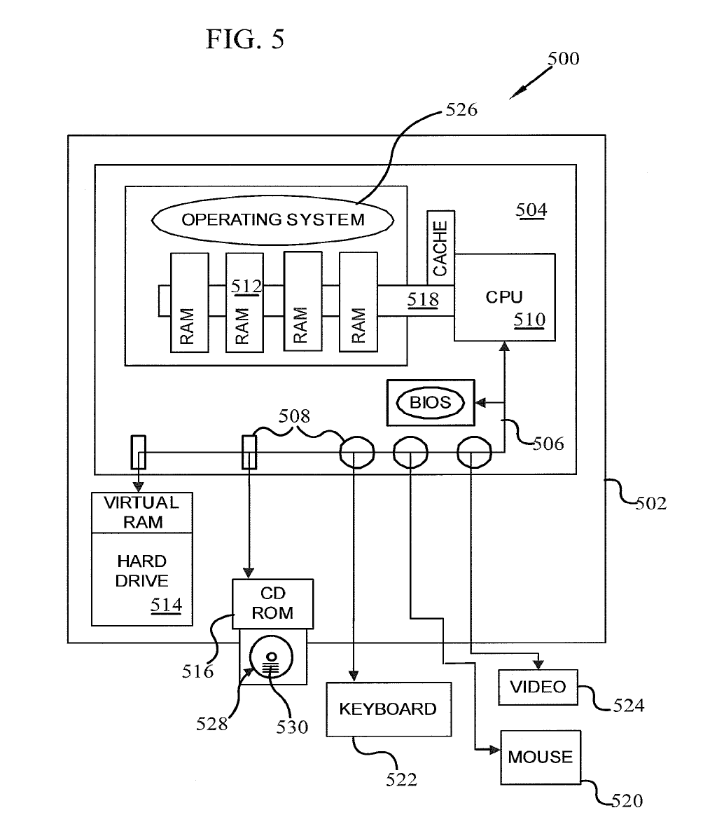

### DETAILED DESCRIPTION

Before proceeding with the detailed description, it is to be appreciated that the present teaching is by way of example only, not by limitation. The concepts herein are not limited to use or application with a specific type of scheduler. Thus, although the instrumentalities described herein are for the convenience of explanation, shown and described with respect to exemplary embodiments, it will be appreciated that the principles herein may be applied equally in other types of schedule prediction systems.

The present disclosure advances the art by providing, in at least one embodiment, a method for determining task scheduling probability.

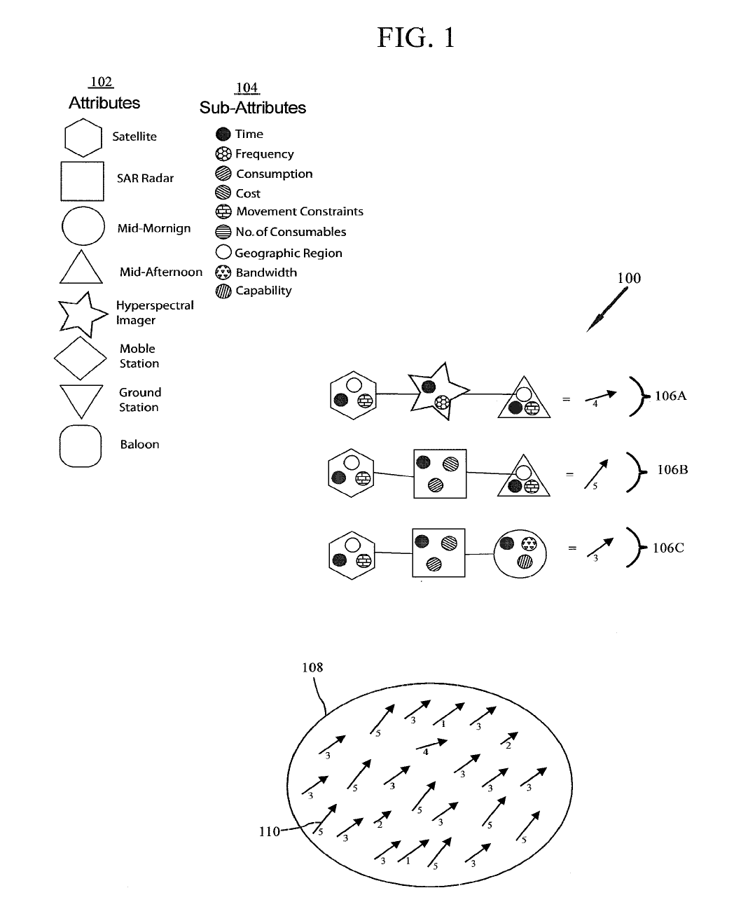

FIG. 1 presents a conceptual view of a new task 100 having a plurality of attributes 102. For the purpose of example, in at least one embodiment it is assumed that the attributes include task type, start execution time and end execution time (in minutes from the start of the day), and priority. As indicated, the task type indicates the type of primary resource required for the task (a satellite, plane, boat, etc. . . . ), as well as the expected duration of the task or other associated elements.

Each attribute may well have sub-attributes 104, such as for example “location over land,” “location over water,”—or even more granularity—“location over Mediterranean Sea” “Location over Mojave desert.” Each attribute and/or sub-attribute may also indicate the resources that are provided or expected, such as for example, time, frequency, consumption, cost, movement constraints, consumables, bandwidth, etc. More generally, the distinction between an attribute and a resource is not intended to be specifically limited to the examples herein provided and for the purposes of this disclosure, the term attribute is understood and appreciated to include elements that might otherwise be considered as resources in different configurations.

As indicated by FIG. 1, the new task 100 may be defined in different ways, utilizing different attributes 102 and/or sub-attributes 104. For purposes of scheduling it is advantageous to know in advance which different possible set of attributes 102 and/or sub-attributes 104 have the greatest probability of scheduling successfully.

For the new task 100, it is understood and appreciated that the attributes and/or sub-elements that comprise the task are elements that may be represented as an n-dimensional vector, wherein “n” is of course dependent upon the number of task attributes associated with the task and numeric values are pre-assigned to each task attribute. For the example new task 100 the initial set of attributes are indicated to include, observation of an area of ocean with an advanced imaging system during daylight hours.

As indicated by the representative shapes, this task may be accomplished in at least a few combinations, a satellite with a hyperspectral imager over water, a satellite with synthetic aperture radar over water, and in windows of mid morning, noon or afternoon. Three possible vectors may be utilized to represent new task 100, e.g. new task vector 106A, 106B or 106C, depending on how the task is actually specified.

Just as new task 100 may be represented as a new task vector 106, so too may prior scheduled tasks be represented as vectors in accordance with the same set of attributes. Indeed, in FIG. 1 there is also shown a database 108 of prior task vectors 110, each prior task vector 110 having been established in accordance with the same set of task attributes utilized in the generation of the new task vector 106.

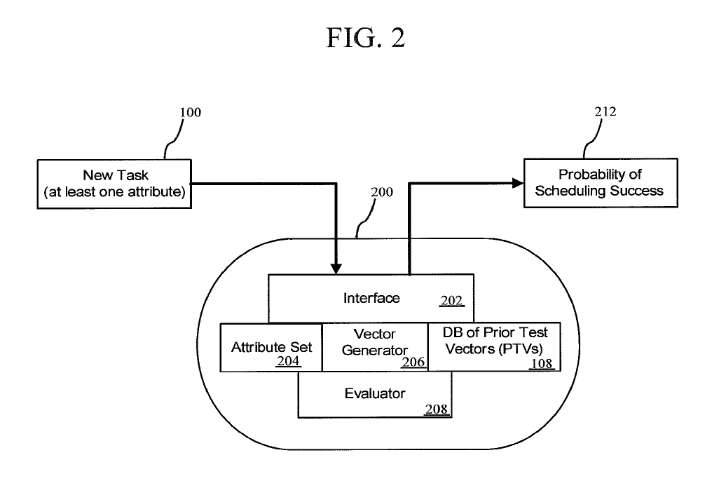

FIG. 2 is a high level block diagram of the system architecture of a system for determining task scheduling probability 200 in accordance with at least one embodiment. Task probability determining system 200 may be implemented on a computer having typical computer components, such as a processor, memory, storage devices, and input and output devices. During operation, task probability determining system 200 may be maintained in active memory for enhanced speed and efficiency. In addition, in at least one embodiment, Task probability determining system 200 may be operated on a computer network and may utilize distributed resources.

Task probability determining system 200 is used to determine task scheduling probability so as to advantageously gage chance of success in scheduling a task. More specifically, if the probability is low, task probability determination system 200 provides this indication of low probability in advance of the actual scheduling attempt so that the operator may adjust one or more task attributes in the exploration for a successful task with an acceptable probability of being scheduled. As shown, task probability determining system 200 includes an interface 202, a set of task attributes 204, a database 108 of prior task vectors (see FIG. 1), a vector generator 206, and an evaluator 208.

The set of attributes 204 are a pre-defined set of attributes and/or sub-attributes that have been previously identified to be of relevance in determining the probability of the new task being successfully scheduled. It is understood and appreciated that for once instance of task probability determining system 200, the attributes may be determined to be set X, whereas for a second instance of the task probability determining system 200, the attribute may be determined to be set Y.

Stated simply, the task probability determining system 200 determines the probability of a new task successfully scheduling by comparing task attributes of the new task to task attributes of prior scheduled tasks. Moreover, a past time period of scheduled tasks selected and reviewed to provide comparison data for use in evaluating the probability of the new task successfully being scheduled.

For a given instance of the task probability determining system 200, the database 108 of prior task vectors 110 is established in accordance with the set of task attributes chosen to apply for that given instance. It is therefore understood and appreciated that different instances of the task probability determining system 200 may both use the same prior scheduled tasks, yet each have a different set of prior task vectors due to a different set of task attributes being applied.

With respect to FIG. 1 and the examples of different task attributes and sub-attributes it is understood and appreciated that each prior scheduled task incorporates at least a subset of the set of task attributes. Moreover, although in certain embodiments, each task may include all of the members of the set of task attributes, in other embodiments, each task may include less than all of the members of the set of task attributes. The same condition exists for the new task 100.

The interface 202 is operable to receive user supplied data, such as a new task having at least a subset of the task attributes. The vector generator 206 is operable to receive the new task 100 from the interface 202 and generate a vector representing the new task 100 based on the new task's attributes.

The evaluator 208 is in communication connection with the database 108 and the generator 206 and is operable to compare the new task vector with at least a subset of the prior task vectors. Moreover, as is further described below, task probability determining system 200 is operable to receive a new task 100 having at least one attribute, and return a probability of scheduling success 212 based upon a comparison of the new tasks attributes with the attributes of prior tasks known to have scheduled.

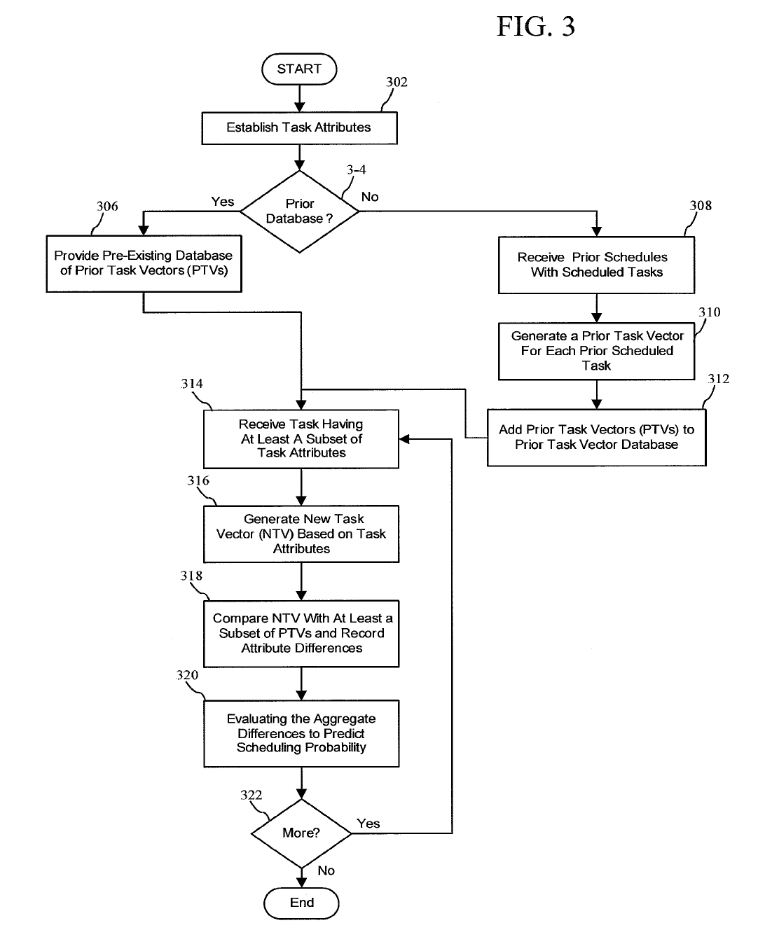

FIG. 3 presents a high level flow diagram illustrating at least one method of determining task scheduling probability in accordance with an embodiment of the present invention. For the sake of example, a hypothetical scheduling task involves a recon of an area of remote geography, specifically an area of the Mediterranean sea during daylight hours and involving a hyperspectrial imaging system. The elements of FIG. 1 are referenced in connection with FIG. 3 so as to provide a contextual flow of this example. It is also understood and appreciated that the disclosed method need not be performed in the order herein described, but that this order of description is exemplary of at least one embodiment and has been selected for ease of discussion and illustration.

As indicated in the flow diagram, the method of determining task scheduling probability commences in at least one embodiment with the establishment of a set of task attributes, block 302. As indicated in FIG. 1, for the present example these attributes include task type (observation, intervention, delivery, etc. . . . ), start time, end time and priority. So as to enable the comparison of new task vector to the prior scheduled task vectors, a database 108 of prior task vectors 110 (PTVs) is provided. If such a database of vectors has been provided in the past, decision 304, that pre-existing database may be obtained and utilized without further delay, block 306.

If the set of task attributes is new, or has not been applied to prior scheduled tasks in a prior schedule, the generation of a new database of PTVs is commenced. Prior schedules with scheduled tasks are obtained, block 308. Utilizing the set of task attributes and the vector generator, PTV's are generated for each prior scheduled task, block 310. The generated PTVs are added to the database of prior task vectors 206, block 312. This generated database of PTVs and the associated set of task attributes may of course be recorded for re-use in the future without requiring re-generation.

With the database of prior task vectors so established, the method 300 is now set to receive a new task for probability evaluation. As indicated, a new task is received, the new task having at least a subset of task attributes, block 314. Based on the subset of task attributes, a new task vector (NTV) is generated, block 316.

With the NTV now generated, a comparison between the NTV and at least a subset of the PTVs provided in the database is performed, block 318. In at least one embodiment the differences between the common elements is noted.

In at least one embodiment, the each PTV 110 is compared to the NTV 106. In at least one alternative embodiment, the comparison is performed with a subset of PTVs established on the basis of each PTV having at lest on attribute in common with the NTV. Further still, where at least one task attribute has a plurality of sub-attribute possibilities, the selection of a PTV for comparison with the NTV is based upon the PTV having sub-attributes in common with the NTV.

The selection of a subset of PTV advantageously returns a predicted probability more rapidly as extraneous comparisons are eliminated. For example and with respect to the present example, as stated the reconnaissance is to be performed over a part of the Mediterranean sea. Any and all prior tasks that that did not involve attributes of being over the sea, or even the sub-attribute of specifically the Mediterranean sea can be eliminated—an action that saves time and resources in performing the unnecessary comparisons. In other words, in at least one embodiment the method advantageously compares the source.

With vectors of PTVs and NTV known, the statistical similarity between the original sets a selected PTV and NTV can be determined. There are several options for comparing these vectors. In at least one embodiment, such a comparison evaluation is performed by computing a metric of the distance between the vectors. The distance may be defined by the following formula:

$$dist \approx \frac{{( {‖ PTV - NTV ‖}_{2} )}^{2}}{2}$$

In other words, the square of the Euclidian distance between a selected PTV and NTV is an estimator of the distance between the two vectors. The smaller the distance the greater the similarity between the two representative vectors. When NTV is compared and evaluated to all member of the PTV database, or in an alternative embodiment, at least a subset of PVTs the similarity between the new task and previously scheduled tasks can be appreciated.

In an alternative embodiment, the comparison between a selected PTV and NTV is evaluated by determining the cosine of the two vectors, which is defined as (n=to the number of task attributes in the set):

$$cos ( PTV , NTV ) = \frac{{\sum }_{i = 1}^{n} {PVT}_{i} {NTV}_{i}}{\sqrt{{\sum }_{i}^{n} {PVT}_{i}^{2}} \sqrt{{\sum }_{i}^{n} {NTV}_{i}^{2}}}$$

In still other embodiments, unmixing between PTV and NTV may be performed. Moreover, as the n-dimensional vectors representing PTV and NTV may be denoted as matrices, many well understood methods may be employed to determine the degree of similarity between the overall vectors and, specifically, the elements within the matrices which are different. Further still, in varying embodiments, it may be desiredable to normalize the PTV and NTV for purposes of comparison.

By evaluating the aggregate differences for each task attribute, the probability of the new task to successfully schedule can be predicted, block 320. In at lest one embodiment, the aggregate differences are returned in their order of hierarchy so as to identify the task attributes having the greatest deviation. By reviewing the aggregate differences for each task attribute, the requesting party may realize changes in the task which may further improve the task scheduling probability. This is more fully appreciated with respect to the example PTV database 108 shown in FIG. 1.

In FIG. 1, each PTV 110 is appreciated to have a sub-number provided as a numeric generalization of the PTV 110. There are twenty four PTVs provided and it is appreciated that there are two values of “1” two values of “2” twelve values of “3” one value of “4” and seven values of “3”. If the NTV 106 of the above example is evaluated to have a numeric generalization of a “4” (e.g., NTV 106A) then the probability of scheduling based on the past scheduled tasks is 1 in 24, or about 4%.

However, if upon review of the aggregate differences of the attributes it is realized that the adjustment of an attribute or sub-attribute (such as opting to use a synthetic aperture radar in place of a hyperspectrial imager) the new task would result in a numeric generalization of NTV as a 5 (e.g., NTV 106B), the odds of successful scheduling increase to 7 in 24, or about 29%. Further still, if the change of the attribute results in a numeric generalization of NTV as a 3 (e g, NTV 106C), the odds increase to 1 in 2, or about 50%. Upon review of the aggregate attributes this might be realized as possible by selecting morning time frame over the original afternoon time frame.

In other words, if the requester reviewed the aggregate data for the attributes and notes that for similar tasks of this type the probability of successful scheduling is very low, the operator may adjust parameters, such as opting to use a synthetic aperture radar in place of a hyperspectral imager and changing the window of execution with the result that the probability of the task successfully scheduling will increase from 1 in 24 to 1 in 2. Predicted in advance, the operator can adjust the actual task attributes before submission to the actual scheduler and thereby increase the probability of the task successfully scheduling.

This assessment has been verified experimentally. Modeling current satellite task loads and utilizing existing schedules from prior task operations, an embodiment of task probability determining system 200 was implemented to perform method 300 in accordance with the following assumptions.

All tasks are independent (due to a limitation in the legacy scheduler).

Each task occupies a single time window (tasks cannot be split).

There are 50 to 60 satellite sensors that can be tasked.

There are 10 to 60 task types, which describe the task's sensor and time requirements. A task type may be able to use more than one satellite to satisfy its requirements.

The scheduler coordinates multiple satellites, targets and sensors.

4800 to 12500 tasks are submitted for scheduling per day.

Tasks are assigned one of five task priorities (lower is more important).

Each task requires from 5 to 120 minutes to complete.

The number of tasks and sensors implies a typical 2:1-4:1 resource oversubscription.

The Knowledge Base (KB) from which analogies can be made includes data from 30 to 365 days.

Each described above, in this experimental model, each task is described by a vector of feature values that include task type, start and end execution times (in minutes from the start of the day), and priority. A task's type determines the satellites it may use, the duration of the task (time, in minutes, for the task to execute), and the length in minutes of the time window during which the task may be scheduled.

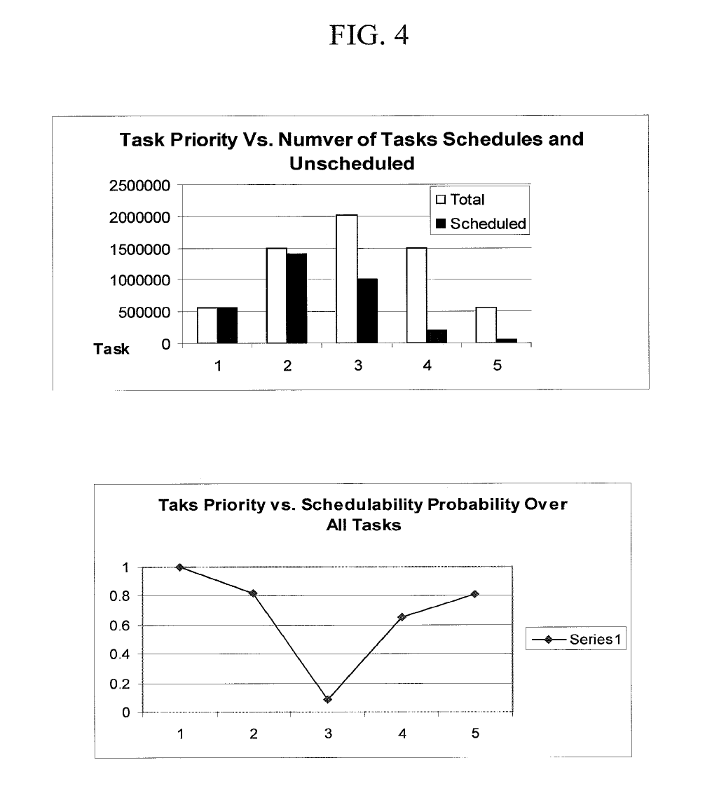

In addition to verifying the advantageous increase in efficiency by searching to match a new task vector to prior task vectors selected on the basis of sharing at least one common attribute, the experiment also verified the effect of changing task parameters varied greatly from parameter to parameter. Certainly for tasks having low priorities, the issue of priority was an important factor, and likewise for tasks having extremely low priorities. However, for tasks having intermediate priorities, the priority parameter demonstrated little importance, see charts of FIG. 4.

In at least one embodiment, the task probability determining system 200 and/or method 300 is implemented as a computer system for scheduling activities. FIG. 8 is a high level block diagram of an exemplary computer system 500. Computer system 500 has a case 502, enclosing a main board 504. The main board has a system bus 506, connection ports 508, a processing unit, such as Central Processing Unit (CPU) 510, and a memory storage device, such as main memory 514, hard drive 514, and CD/DVD Rom drive 516.

Memory bus 518 couples main memory 512 to CPU 510. A system bus 506 couples hard drive 514, CD/DVD Rom drive 516, and connection ports 508 to CPU 510. Multiple input devices may be provided, such as for example a mouse 520 and keyboard 522. Multiple output devices may also be provided, such as for example a video monitor 524 and a printer (not shown).

Computer system 500 may be a commercially available system, such as a desktop workstation unit provided by IBM, Dell Computers, Gateway, Apple, Sun Micro Systems, or other computer system provider. Computer system 500 may also be a networked computer system, wherein memory storage components such as hard drive 514, additional CPUs 510 and output devices such as printers are provided by physically separate computer systems commonly tied together in the network. Those skilled in the art will understand and appreciate that physical composition of components and component interconnections comprising computer system 500, and select a computer system 500 suitable for the schedules to be established and maintained.

When computer system 500 is activated, preferably an operating system 526 will load into main memory 512 as part of the boot strap startup sequence and ready the computer system 500 for operation. At the simplest level, and in the most general sense, the tasks of an operating system fall into specific categories—process management, device management (including application and user interface management) and memory management.

In such a computer system 500, the CPU 510 is operable to perform one or more of the scheduling embodiments described above. Those skilled in the art will understand that a computer-readable medium 528 on which is a computer program 530 for adding activities to a schedule may be provided to the computer system 500. The form of the medium 528 and language of the program 530 are understood to be appropriate for computer system 500. Utilizing the memory stores, such as for example one or more hard drives 514 and main system memory 512, the operable CPU 502 will read the instructions provided by the computer program 530 and operate to perform as the task probability determining system 200 and/or method 300 as described above.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A method of determining task scheduling probability, comprising:
establishing a set of task attributes;
providing a database of prior task vectors in accordance with the set of task attributes, each prior task vector representing a prior scheduled task;
receiving a new task having at least a subset of the task attributes;
generating a new task vector based on the new task attributes;
comparing the new task vector to at least a subset of the prior task vectors and recording the differences between each task attribute; and
evaluating the probability of the new task scheduling successfully based upon the aggregate differences for each attribute.

2. The method of claim 1, wherein providing the database includes:
receiving a plurality of prior scheduled tasks; and
generating a prior task vector for each prior scheduled task based on the task attributes, and
inputting each prior task vector into the database.

3. The method of claim 1, wherein comparing the new task vector to each prior task vector is performed with prior task vectors having at least one attribute in common with the new task vector.

4. The method of claim 1, wherein at least one task attribute has a plurality of sub-attribute possibilities, and further comprising comparing the new task vector to each prior task vector being performed with prior task vectors having sub-attributes in common with the new task vector.

5. The method of claim 1, wherein all prior task vectors are compared to the new task vector.

6. The method of claim 1, wherein the aggregate differences are returned in order of hierarchy.

7. The method of claim 1, wherein in at least one embodiment the task attributes include task type, start execution time, end execution time, and priority.

8. The method of claim 7, wherein task type determines task resources and task duration.

9. The method of claim 1, further including adding the new task vector to the data base of prior tasks vectors upon operator direction.

10. The method of claim 1, wherein multiple instances of the method may be performed concurrently.

11. The method of claim 1, wherein multiple instances each employ a different set of task attributes.

12. The method of claim 1, wherein the method is stored on a computer-readable medium as a computer program which, when executed by a computer will perform the steps of determining task scheduling probability.

13. A system for determining task scheduling probability, comprising:
a set of task attributes;
a database operable to provide at least one prior task vector established in accordance with the set of task attributes, each prior task vector representing a prior scheduled task;
an interface operable to receive a new task having at least a subset of the task attributes;
a generator operable to receive the new task from the interface and generate a new task vector based on the new task attributes; and
an evaluator in connection with the database and the generator and operable to compare the new task vector with at least a subset of the prior task vectors and record the difference for each task attribute, the aggregate differences for each task attribute indicating a probability of the new task scheduling successfully.

14. The system of claim 13, wherein the evaluator is operable to compare the new task vector with prior task vectors having at least one attribute in common with the new task vector.

15. The system of claim 13, wherein at least one task attribute has a plurality of sub-attribute possibilities, the evaluator operable to compare the new task vector to each prior task vector having sub-attributes in common with the new task vector.

16. The system of claim 13, wherein the evaluator is operable to compare the new task vector with all prior task vectors.

17. The system of claim 13, wherein the interface is further operable to receive the aggregate differences from the evaluator and return the aggregate differences to a designated receiver.

18. The system of claim 13, wherein in at least one embodiment the task attributes include task type, start execution time, end execution time, and priority.

19. The system of claim 18, wherein task type determines task resources and task duration.

20. A computer-readable medium on which is stored a computer program for determining task scheduling probability, the computer program comprising instructions which, when executed by a computer, perform the steps of:
establishing a set of task attributes;
providing a database of prior task vectors in accordance with the set of task attributes, each prior task vector representing a prior scheduled task;
receiving a new task having at least a subset of the task attributes;
generating a new task vector based on the new task attributes;
comparing the new task vector to at least a subset of the prior task vectors and recording the differences between each task attribute; and
evaluating the probability of the new task scheduling successfully based upon the aggregate differences for each attribute.

21. The computer-readable medium of claim 20, wherein providing the database includes:
receiving a plurality of prior scheduled tasks; and
generating a prior task vector for each prior scheduled task based on the task attributes, each prior task vector added to the database.

22. The computer-readable medium of claim 20, wherein comparing the new task vector to each prior task vector is performed with prior task vectors having at least one attribute in common with the new task vector.

23. The computer-readable medium of claim 20, wherein at least one task attribute has a plurality of sub-attribute possibilities, and further comprising comparing the new task vector to each prior task vector being performed with prior task vectors having sub-attributes in common with the new task vector.

24. The computer-readable medium of claim 20, wherein all prior task vectors are compared to the new task vector.

25. The computer-readable medium of claim 20, wherein the aggregate differences are returned in order of hierarchy.

26. The computer-readable medium of claim 20, wherein in at least one embodiment the task attributes include task type, start execution time, end execution time, and priority.

27. The computer-readable medium of claim 26, wherein task type determines task resources and task duration.

28. The computer-readable medium of claim 20, wherein multiple instances of the method may be performed concurrently.

29. The computer-readable medium of claim 20, wherein multiple instances each employ a different set of task attributes.
